(19) United States
(12) Patent Application Publication
(10) Pub. No.: US 2014/0067148 A1
(43) Pub. Date: Mar. 6, 2014

(54) CONFIGURATION OF THE COMMUNICATION LINKS OF FIELD DEVICES IN A POWER AUTOMATION INSTALLATION

(71) Applicants: Thomas Jachmann, Fuffalo Grove, IL (US); Gunther Reichenbach, Burgthann (DE); Norbert Schuster, Allersberg (DE)

(72) Inventors: Thomas Jachmann, Fuffalo Grove, IL (US); Gunther Reichenbach, Burgthann (DE); Norbert Schuster, Allersberg (DE)

(73) Assignee: SIEMENS AKTIENGESELLSCHAFT, MUENCHEN (DE)

(21) Appl. No.: 13/812,665

(22) PCT Filed: Jul. 27, 2010
(86) PCT No.: PCT/EP10/60892

§ 371 Date: Mar. 18, 2013

(51) Int. Cl. H02J 4/00

(52) U.S. Cl. CPC H02J 4/00
USPC 700/295

(57) ABSTRACT

A method configures field devices with confidence against incorrect settings. A graphics editor has a first display area, which contains a graphics display of functions of a first field device, and a second display area which contains a graphics display of a further field device which is connected to the first field device and displays indications of possible output signals. A selection by a user of an output signal from the further field device and of a function of the first field device is detected. Parameter sets are produced which contain instructions for configuring a communication link of the first field device and of the further field device which, when a selected output signal is present for the further field device, indicate that a data message has been sent to the first field device and that the selected function of the first field device has been initiated.

The invention relates to a method for configuring field devices in a power automation installation and to a data processing device which can be used to perform such a configuration.

Power automation installations are used for automating electrical power supply systems and usually comprise what are known as field devices which are arranged in proximity to primary components of the electrical power supply system. By way of example, such primary components may be electrical cables and lines, transformers, generators, motors or converters. Usually, the electrical field devices in this case record measured values which describe the operating state of the respective primary components of the electrical power supply system. These measured values can be either stored or forwarded to the respective field device of superordinate control and monitoring components of the power automation system. Furthermore, field devices in the form of what are known as “protective gear” may be set up to use special algorithms to check the recorded measured values to determine whether they denote an admissible or inadmissible operating state of the respective primary component of the electrical power supply system. In the case of an inadmissible operating state, suitable measures are tripped (e.g. opening a circuit breaker) in order to protect the primary component against damage or to protect people against injury. An inadmissible operating state may be a short on a line in an electrical power supply system, for example.

The field devices in the power automation installation are usually not just connected to hierarchically superordinate control and monitoring appliances but also have communication links among one another for what is known as “cross-communication”, in order to be able to interchange data and commands with one another in the shortest possible time, i.e. as far as possible in “real time”, said data and commands allowing a suitable reaction to the respectively identified operating state of the respective primary component.

By way of example, such cross-communication can involve the transmission of information about an identified inadmissible operating state or commands for tripping a circuit breaker controlled by the receiving field device (what is known as a “transfer trip signal”) or for blocking a circuit breaker controlled by the receiving field device (what is known as a “blocking signal” or “locking signal”).

In conventional power automation installations for electrical power supply systems, this was accomplished by virtue of the individual field devices being connected to one another by means of hardwiring using analog-operation or digital-operation inputs and outputs, that is to say by means of electrical lines laid separately between the individual field devices. This required a high level of wiring complexity.

In more recent power automation installations, the new approach has therefore been adopted of connecting the individual field devices of the power automation installation to a common communication network, such as an Ethernet communication network, and interchanging the respective data and commands between the field devices in the form of data telegrams. Such a design is known from the “IEC 61850” standard from the “International Electro-technical Commission”, for example, which standard regulates communication in power automation installations. IEC 61850 is the current and future governing communication standard in the area of power automation. The standard is taken as a basis for describing what are known as “GOOSE data telegrams” (GOOSE=Generic Object Oriented Substation Events), inter alia, which allow cross-communication between the individual field devices in order to interchange data and commands directly between the individual field devices of the power automation installation particularly quickly and efficiently.

In line with the laying and electrical connection of separate instances of hardwiring in conventional power automation installations, it is also necessary for the individual communication links in the respective field devices—and possibly also in a superordinate control device—to be set up or configured when setting up, commissioning or altering the modern power automation installation which sends data telegrams for the purpose of cross-communication between the field devices. By way of example, the configuration of such communication links comprises the stipulation of senders and receivers of individual data telegrams, the setting of addresses to be used for the communication and the stipulation of the reactions by the receiver to the reception of a particular data telegram.

Today, this configuration is usually accomplished using what is known as a system configurator. A system configurator is a standalone software program which allows settings for data telegrams, e.g. GOOSE messages, to be bundled in the form of what are known as “datasets” across the entire power automation installation. The settings stipulated in the datasets are intended to be used for the cross-communication of the field devices. They are used to define the source and destination of the individual data telegrams. To this end, the user of a system configurator needs to manually link many different items of information to one another and produce therefrom settings both for the individual field devices and for further superordinate control devices in the power automation installation.

Besides the large number of actions that need to be performed by the user of the power automation installation, a fundamental disadvantage of this manual configuration can above all also be considered to be the fact that the user requires in-depth knowledge of the control mechanism that governs the communication settings, that is to say IEC 61850 in the case of GOOSE messages, even for comparatively simple instances of application. The manual settings have a high associated risk of error, and the subsequent search for such errors is very complex.

The invention is therefore based on the object of specifying a method for configuring communication links between field devices in a power automation installation in which a user of the power automation installation can perform configurations with a high level of security against misadjustments even without in-depth knowledge of a control mechanism which governs the communication.

This object is achieved by proposing a method for configuring field devices in a power automation installation, in which a graphical editor is executed using a data processing device, wherein the editor has a first display area which comprises a graphical representation of functions of a first field device in the power automation installation, and wherein the editor has a second display area which comprises a graphical representation of at least one further field device, which is connected to the first field device by means of a physical communication medium, in the power automation installation and an indication of possible output signals which can be produced by the at least one further field device during the operation thereof. A user selection firstly of an output signal from the at least one further field device in the second display area and secondly of a function of the first field device in the first display area is captured and a first parameter set for the first and at least one further parameter set for the at least one further field device are produced, wherein the parameter sets comprise instructions for configuring the communication link between the first and the at least one further field device which, when the selected output signal of the at least one further field device is present, indicate sending of a data telegram from the at least one further field device to the first field device and the tripping of the selected function of the first field device upon reception of the data telegram by the first field device.

In this way, the user of the power automation installation can set up a communication link between the field devices without technical difficulties, without this requiring possession of in-depth knowledge of the underlying control mechanism. As a result of the actions performed in the editor, the parameter sets required for implementing the communication link are automatically produced for the field devices involved. It is therefore possible for the required parameter sets to be produced in one common step. The user of the power automation installation can also configure the cross-communication without changing between different tools and directly at the level of the field devices involved.

In one advantageous embodiment of the method according to the invention, the first and the at least one further field device are field devices in a power automation installation, the design and function of which are described using an installation description file, and the parameter sets are also used for customizing the installation description file.

By way of example, such an installation description file can be used at system level in control center devices which are superordinate to the field devices of the power automation installation, and is able to stipulate functions of the power automation installation which span field devices (e.g. communication between the field devices) in said control center devices. For consistent operation of the power automation installation, it is necessary for the content of settings in the parameter sets and in the installation description file to match. With the embodiment described, the parameter sets are used not only for setting the field devices but also for automatically customizing the installation description file, so that the consistency of the settings is ensured.

In this connection, provision may furthermore advantageously be made for the installation description file to indicate the field devices which belong to the power automation installation, and the second display area to be produced by ascertaining those further field devices which the installation description file comprises which are connected to the first field device by means of a physical communication medium and including the ascertained further field devices in the second display area.

This means that mere knowledge of the field devices which are connected to one another by means of the communication medium on the basis of the installation description file automatically allows the available selection options to be produced in the second selection area of the editor without this requiring further manual settings.

Specifically, provision may be made in this connection for the installation descriptions file to be an SCD file (SCD=Substation Configuration Description) based on the IEC 61850 standard.

As an alternative to producing the content of the second display area from an installation description file, provision may also be made for the second display area to be produced by performing a check to determine which further field devices are connected to the first field device by means of a physical communication medium and including the further field devices which are identified during the check in the second display area.

In this way, only the further field devices which are actually in contact with the first field device by means of the physical communication medium are taken into consideration for producing the second selection area.

Specifically, provision may also be made for the data telegrams to be in the form of GOOSE messages based on the IEC 61850 standard.

In a further advantageous embodiment of the method according to the invention, the data processing device is part of the first field device.

In this way, the parameter sets required can be produced directly in the first field device, which needs to have a graphical user interface that can be operated by the user in order to execute the editor. The parameter set for the first field device can be used directly in the first field device, whereas the parameter set for the at least one further field device needs to be transmitted thereto.

Alternatively, however, provision may also be made for the data processing device to be a configuration computer which is set up to execute a configuration program.

In this embodiment, a configuration computer in the form of a PC or a laptop, on which a piece of configuration software, e.g. the configuration program “DIGSI” from Siemens AG, is installed, is used for executing the graphical editor and for ascertaining the parameter sets. Usually, working on such a configuration computer will be more comfortable for the user on account of larger screen displays and easier-to-use input devices (keyboard, mouse). In this case, the ascertained parameter sets need to be transmitted to all the field devices involved.

In addition, in a further advantageous embodiment, the field devices have adjustable communication devices and the first parameter set is transmitted to the first field device and the at least one further parameter set is transmitted to the at least one further field device, and the field devices set their respective communication devices in line with the instructions which the parameter sets contain.

The object cited above is also achieved by a power automation installation having configurable field devices, a physical communication medium between at least a few of the field devices and a data processing device, wherein the data processing device is set up to configure the communication between the at least a few field devices by performing a method as claimed in one of claims 1 to 9.

The invention will be explained in more detail below using an exemplary embodiment. To this end

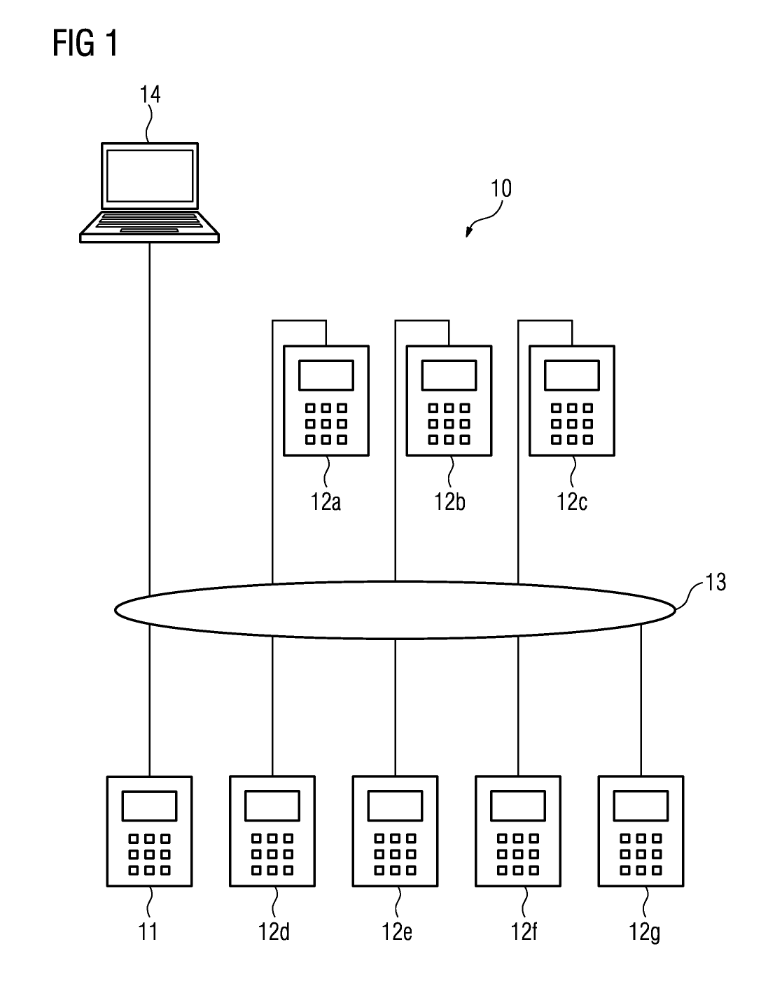

FIG. 1 shows a schematic illustration of a power automation installation with a plurality of field devices;

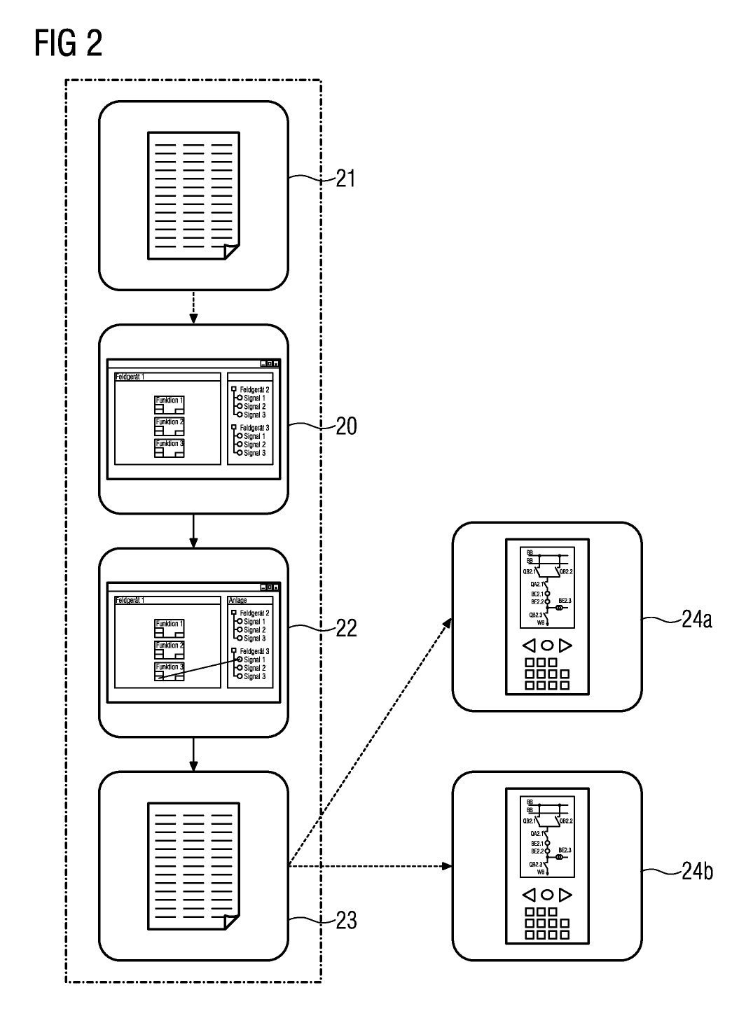

FIG. 2 shows a schematic flowchart for a method for configuring field devices; and

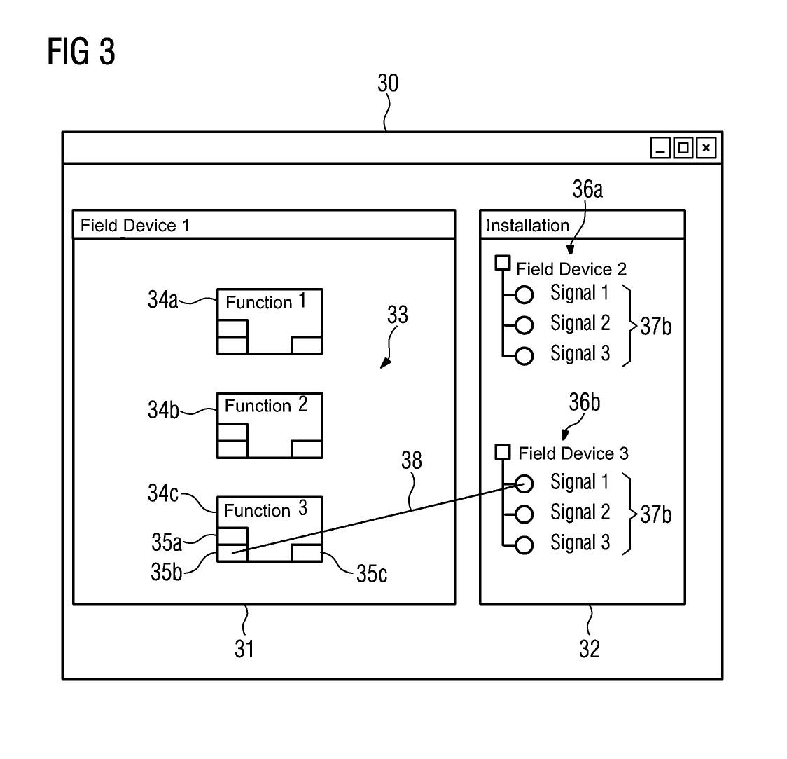

FIG. 3 shows a schematic view of an exemplary embodiment of a graphical editor for configuring field devices.

FIG. 1 shows a power automation installation 10 for controlling and monitoring an electrical power supply system—not shown in FIG. 1 for the sake of clarity. The power automation installation 10 has a first field device 11, which is a piece of electrical protective gear or a control-engineering device, for example. Such and other field devices for automating power supply systems are usually also referred to as “IEDs” (IED=“Intelligent Electronic Device”) in the technical terminology. In the text below, the term “field device” will be used for protective gear, control-engineering devices, measuring devices (RTUs) and further automation devices for power automation installations that are usually covered by the term IED.

The power automation installation 10 also comprises further field devices 12a to 12g. For the purpose of interchanging data telegrams with one another, the field devices 11 and also 12a to 12g have communication devices with interfaces to a physical communication medium in the form of a communication network 13, which may be an Ethernet communication network, for example. In this case, the communication network 13 may be designed to have a star or ring topology, for example; the specific design is unimportant to the performance of the method described below. Similarly, the communication network 13 may be wired or wireless. The field devices 11 and also 12a to 12g control and/or monitor primary components of the electrical power supply system which are not shown in FIG. 1.

Furthermore, the field devices 11 and also 12a to 12g may also be connected to hierarchically superordinate control and monitoring devices in the power automation installation 10, such as a station monitoring device or a power system control center; such connections are not shown in FIG. 1, however, for the sake of clarity.

During the operation of the power automation installation 10, the field devices 11 and also 12a to 12g use the communication network 13 to interchange data telegrams which contain information which needs to be transmitted within the power automation installation in real time (that is to say without any significant delay as a result of transmission and/or further processing steps) as far as possible.

Information which the data telegrams contain may be state changes in a primary component of the electrical power supply system that is monitored or controlled by the respective field device 11 or 12a to 12g, for example. By way of example, such a state change may indicate that a short has occurred on a line section in the electrical power supply system. In this case, the data telegrams may contain either mere information about the state change or else commands to other field devices which are meant to prompt the latter to open, close or block a circuit breaker, for example.

If the automation installation is set up on the basis of the IEC 61850 communication standard, the data telegrams transmitted by the communication network 13 may be what are known as GOOSE data telegrams or GOOSE messages. On the basis of the IEC 61850 standard, such GOOSE messages are sent to all or a few selected receiver field devices simultaneously by one field device using what is known as a multi-cast or broadcast method. In this case, the IEC 61850 standard provides for regular repetition of the GOOSE data telegrams, said repetitions being able to be effected at a relatively high frequency for critical state changes. This allows the state of the primary components monitored by the field devices 11 and also 12a to 12g to be distributed throughout the automation installation on a continually up-to-date basis and state changes to be circulated in the automation installation under high realtime conditions.

However, not all possible types of information which the data telegrams contain are relevant to all the other field devices in the automation installation, which means that particular data telegrams from a sending field device in the automation installation may have a respective associated selected receiver circle of further field devices.

Since the correct transmission of the data telegrams transmitted between the field devices is of great importance to the proper operation of the power automation installation, the communication links used to transmit the data telegrams need to be configured with great care, at least when commissioning the power automation installation and also in the event of changes on the power automation installation. In this context, the term “communication link” is intended to be understood to mean particularly the respective transmission reception settings in the field devices 11 and 12a to 12g, since these transmission and reception settings are responsible for the data telegrams being correctly transmitted to the communication network 13, received by the correct receiver circle within the field devices 11 and also 12a to 12g and, when they have been received, prompting the desired reactions in the respective field device.

For the purpose of performing configuration of the communication links between the first field device 11 and at least one further field device 12a to 12g, a data processing device 14 is used which is shown in FIG. 1 merely by way of example in the form of a laptop, which is likewise connected to the communication network 13. Instead of the laptop, such a data processing device 14 can also be formed by other suitable separate data processing devices (e.g. desktop PCs), or else may be part of one of the field devices 11 and 12a to 12g.

The text below will make reference to FIGS. 2 and 3 in order to provide a more detailed explanation of an exemplary embodiment of a method for configuring a communication link between the first field device 11 and a further field device 12a. To this end, FIG. 2 shows a schematic flowchart for an exemplary embodiment of a method for configuring a communication link between the field devices 11, 12a to 12g. In this case, it is intended to be assumed that the field devices 11, 12a to 12g and the communication network 13 are set up on the basis of the IEC 61850 standard and therefore data telegrams in the form of GOOSE messages are transmitted for the purpose of cross-communication between the field devices 11, 12a to 12g. Specifically, the aim is to consider, by way of example, the instance of application in which a trip signal produced by the field device 12a is intended to prompt a GOOSE message which is transmitted to the first field device 11 and is intended to prompt the latter to block a trip signal generated by the first field device 11 itself. Such a scenario is entirely usual in power automation installations and is used, by way of example, when a plurality of items of protective gear identify an error on a line in the power supply system, but only the item of protective gear which is closest to the error (in this case the field device 12a) is actually intended to trip.

In order to configure such a communication link, the data processing device 14 executes a graphical editor on the basis of a first step 20 (cf. FIG. 2). An exemplary embodiment of such a graphical editor 30 is shown in FIG. 3 by way of example.

The graphical editor 30 has a first selection area 31 and also a second selection area 32. The first selection area 31 comprises a graphical representation of functions of the first field device 11 in the power automation installation 10. This representation is shown in this case merely by way of example in the form of a logic diagram 33 with individual logic modules 34a, 34b, 34c. The first display area can naturally present more or fewer functions depending on the actual scope of functions of the first field device; for the sake of clarity, only three such functions have been shown in FIG. 3. A logic diagram 33, as shown in FIG. 3, is also known as a “CFC editor” and allows graphical representation and linking of individual logic modules. In this case, each logic module is a fundamental function of the field device 11 that can be linked to other logic modules by means of inputs, e.g. inputs 35a and 35b of the logic module 34c, and outputs, e.g. the output 35c of the logic module 34c. As an alternative to the first selection area 31 being present in the form of a logic diagram, it may also be in the form of a signal assignment matrix or a single line editor, for example.

The second selection area 32 of the editor 30 shows a graphical representation of further field devices 12a to 12g, which are connected to the first field device 11 (cf. FIG. 1) by means of a physical communication medium in the form of the communication network 13, and an indication of possible output signals which can be produced by the further field devices during the operation thereof. Merely by way of example, FIG. 3 shows graphical representations 36a and 36b of two further field devices, which each comprise indications 37a and 37b about the possible output signals from these further field devices, in a tree structure in the second selection area 32. The second selection area 32 may naturally have further entries beyond the presentation in FIG. 3, but these have been omitted for the sake of clarity in the exemplary embodiment shown here.

The second selection area 32 is therefore an overview of those further field devices 12a to 12g which are connected to the first field device 11 in the power automation installation 10 by means of the communication network 13. The possible output signals from these further field devices are therefore available for the functions of the first field device, which means that GOOSE messages can be configured therefor. The second selection area can be produced by performing the optional step 21 (cf. FIG. 2), for example, according to which an installation description file which is present anyway for describing the function and design of the power automation installation 10 is used to determine the further field devices 12a to 12g that are connected to the first field device 11 and also an indication about the output signals that can be produced by said further field devices.

In the case of a power automation installation 10 which is set up on the basis of the IEC 61850 standard, such an installation description file is provided by what is known as the “SCD” (“Substation Configuration Description”). Such an SCD can be kept in a control device (not shown in FIG. 1) which is superordinate to the field devices 11, 12a to 12g and/or in one or more of the field devices 11, 12a to 12g themselves, for example.

As an alternative to determining the further field devices 12a to 12g that are to be presented in the second selection area 32 of the editor 30 from the installation description file, it is also possible for the further field devices 12a to 12g that are actually connected to the first field device 11 to be requested, for example, by virtue of the data processing device 14, for example, producing a broadcast message which comprises an identification request to the field devices 11, 12a to 12g which receive this message. As a reaction to the identification request, the field devices 11, 12a to 12g return an identification (e.g. an explicit device number) and also an indication about the output signals which they can produce to the data processing device 14. These responses from the field devices 11, 12a to 12g can be used by the data processing device 14 to produce the second selection area 32, this being accomplished merely by taking into consideration the responses from the further field devices 12a to 12g that are connected to the first field device 11.

If the editor 30 is executed by the first field device 11 itself instead of the data processing device 14, the two alternatives for producing the second selection window are performed in corresponding fashion directly by the first field device 11 itself.

In a further step 22 (cf. FIG. 2), both a user selection of an output signal from a further field device 12a to 12g in the second display area 32 and a user selection of a function of the first field device 11 in the first display area 31 are captured. With reference to FIG. 3, it may be assumed, on the basis of the instance of application described above, that the field device denoted by “field device 3” is meant to be the graphical representation 36b of the further field device 12a, and the indication 37b—denoted by “signal 1”—of a possible output signal from this further field device 12a is meant to denote a trip signal. This output signal is now intended to be linked to a blocking function (this is meant to be shown in FIG. 3 by the logic module 34c denoted by “Function 3”). To this end, the user of the editor 30 selects both the “signal 1” and an input 35b of the logic module 34c and links them. By way of example, this linking is shown in FIG. 3 by a linking line 38.

This user selection is captured on the basis of step 22 and, on the basis of step 23, is converted into a first parameter set for the first field device 11 and a further parameter set for the further field device 14a, these parameter sets comprising instructions for configuring the communication link between the first field device 11 and the further field device 12a which, when the output signal “signal 1” from the further field device 12a is present, indicate sending a GOOSE message from the further field device 12a to the first field device 11 and the tripping of the selected function “function 3” of the first field device 11 upon reception of the data telegram by the first field device 11. This involves automatic setup of all the settings which are required for sending and receiving this GOOSE message both in the first field device 11 and in the further field device 12a, including the setup of an appropriate data set in the further field device 12a. Furthermore, the properties of the GOOSE message, such as address settings and the reaction to be triggered by the GOOSE message, are stipulated automatically. In this case, provision may be made either for the GOOSE message to be sent from the further field device 12a directly to the first field device 11 by using an appropriate receiver address for the first field device 11, or for the GOOSE message to be sent as a broadcast or multi-cast message in the communication network and for the first field device to be set such that it allows reception of this GOOSE message. Furthermore, it is also possible for an installation description file to be customized automatically by entering the now configured communication link therein.

In final steps 24a and 24b, the first parameter set is transmitted to the first field device 11 and the second parameter set is transmitted to the second field device 12a. This can be accomplished by means of the communication network 13 or using a data storage medium, for example. The parameter sets are interpreted by the respective field device such that the respective communication devices of said parameter sets are set such that the desired communication link—that is to say the production of a GOOSE message by the further field device 12a when the trip signal (“signal 1”) is present, the reception of the GOOSE message by the first field device 11 and the activation of the blocking signal (“function 3”) from the first field device 11—is set up.

Besides the settings for this communication link, the parameter sets naturally may also comprise settings for further communication links and also for other functions of the respective field devices.

The method described for configuring field devices relocates the system configuration at system level that has been necessary to date for setting up communication links in conventional power automation installations to the level of the device configuration and allows highly simplified configuration of the cross-communication between the individual field devices. The user can achieve a high level of benefit with minimal complexity for himself and thereby avoids the risk of performing erroneous configurations—which have an adverse or even safety-critical manifestation during operation of the field devices—as a result of incorrect manual adjustments. Thorough knowledge of the control mechanisms that govern the communication links, e.g. the IEC 61850 standard, the technical terminology thereof and the elements that need to be used for configuration is not required in this case.

1-10. (canceled)

11. A method for configuring field devices in a power automation installation, which comprises the steps of:
executing a graphical editor using a data processing device, the graphical editor containing a first display area having a first graphical representation of functions of a first field device in the power automation installation, the graphical editor further containing a second display area having a second graphical representation of at least one further field device, the at least one further field device connected to the first field device by a physical communication medium in the power automation installation, the second graphical representation further showing an indication of possible output signals which can be produced by the at least one further field device during an operation thereof;
capturing a user selection of an output signal from the at least one further field device in the second display area and capturing a user selection of a function of the first field device in the first display area; and
producing a first parameter set for the first field device and producing at least one second parameter set for the at least one further field device, the first and second parameter sets contain instructions for configuring a communication link between the first field device and the at least one further field device which, when a selected output signal of the at least one further field device is present, indicate sending of a data telegram from the at least one further field device to the first field device and a tripping of a selected function of the first field device upon reception of the data telegram by the first field device.

12. The method according to claim 11, wherein:
the first field device and the at least one further field device are field devices in the power automation installation, a design and function of the field devices are described using an installation description file; and
the first and second parameter sets are also used for customizing the installation description file.

13. The method according to claim 12, wherein:
the installation description file indicates the field devices which belong to the power automation installation; and
the second display area is produced by ascertaining those further field devices which the installation description file contains which are connected to the first field device by means of the physical communication medium and including ascertained further field devices in the second display area.

14. The method according to claim 12, wherein the installation description file is a substation configuration description file based on an International Electro-Technical Commission (IEC) 61850 standard.

15. The method according to claim 11, which further comprises producing the second display area by performing a check to determine which further field devices are connected to the first field device by means of the physical communication medium and including the further field devices which are identified during the check in the second display area.

16. The method according to claim 11, wherein the data telegram is in a form of generic object oriented substation event messages based on an International Electro-Technical Commission (IEC) 61850 standard.

17. The method according to claim 11, wherein the data processing device is part of the first field device.

18. The method according to claim 11, wherein the data processing device is a configuration computer which is set up to execute a configuration program.

19. The method according to claim 11, which further comprises:
providing the field devices with adjustable communication devices; and
transmitting the first parameter set to the first field device and the at least one second parameter set is transmitted to the at least one further field device, and the field devices set the communication devices in line with the instructions which the first and second parameter sets contain.

20. A power operation installation, comprising:
configurable field devices;
a physical communication medium connecting at least a few of said configurable field devices to each other; and
a data processing device set up to configure communication between at least a few of said configurable field devices by performing a method for configuring said configurable field devices, said data processing device programmed to:
execute a graphical editor via said data processing device, the graphical editor containing a first display area having a first graphical representation of functions of a first of said configurable field devices, the graphical editor containing a second display area having a second graphical representation of at least one further one of said configurable field devices, said further configurable field device connected to said first configurable field device by said physical communication medium, the second graphical representation further showing an indication of possible output signals which can be produced by said at least one further configurable field device during an operation thereof;
capture a user selection of an output signal from said at least one further configurable field device in the second display area and capture a user selection of a function of said first configurable field device in the first display area;
produce a first parameter set for said first configurable field device and produce at least one second parameter set for said at least one further configurable field device, wherein the first and second parameter sets contain instructions for configuring the communication link between said first configurable field device and said at least one further configurable field device which, when a selected output signal of said at least one further configurable field device is present, indicate sending of a data telegram from said at least one further configurable field device to said first configurable field device and a tripping of a selected function of said first field device upon reception of the data telegram by said first configurable field device.
